(19) United States
(12) Patent Application Publication
(10) Pub. No.: US 2015/0120379 A1
(43) Pub. Date: Apr. 30, 2015

(54) Systems and Methods for Passage Selection for Language Proficiency Testing Using Automated Authentic Listening

(71) Applicant: Educational Testing Service, Princeton, NJ (US)

(72) Inventors: Chong Min Lee, Pennington, NJ (US); Su-Youn Yoon, Hamilton, NJ (US); Lei Chen, Pennington, NJ (US)

(21) Appl. No.: 14/528,921

(22) Filed: Oct. 30, 2014

Related U.S. Application Data
(60) Provisional application No. 61/897,360, filed on Oct. 30, 2013.

(51) Int. Cl. G06Q 30/02

(52) U.S. Cl. CPC G06Q 30/02
USPC 705/7.29

(57) ABSTRACT

Test designers looking for test ideas often search online for audio/video materials. To minimize the time wasted on irrelevant/inappropriate materials, this invention describes a system, apparatus, and method of retrieving media materials for generating test items. In one example, the system may query one or more data sources based on a search criteria for retrieving media materials, and receive candidate media materials based on the query, each of which including an audio portion. The system may obtain a transcription of the audio portion of each of the candidate media materials. The system may analyze the transcription for each candidate media material to identify associated characteristics. The candidate media materials may be filtered based on the identified characteristics to derive a subset of the candidate media materials. A report may then be generated for the user identifying one or more of the candidate media materials in the subset.

### CROSS-REFERENCE TO RELATED APPLICATIONS

The present application claims from the benefit of U.S. Provisional Application Ser. No. 61/897,360, entitled “Automated Authentic Listening Passage Selection System for the Language Proficiency Test,” filed Oct. 30, 2013, the entirety of which is hereby incorporated by reference.

### FIELD

This disclosure is related generally to automated information retrieval and more particularly to automated retrieval and selection of media appropriate for developing test items.

### BACKGROUND

Developing test items, such as those for reading and listening proficiency tests, may be labor-intensive and time-intensive. Test developers often spend hours browsing for examples online to get inspiration for new test items, as real-life examples could help developers diversify the genre or topic of test items and make the language used sound more natural. Typically, test developers query for audios and videos using conventional search engines (e.g., Google.com), review the search results, and select examples as seed materials for developing new test items. The process of reviewing search results is especially time consuming since the results are audio and/or video clips.

### SUMMARY

Test designers looking for test ideas often search online for audio/video materials. Unfortunately, they often have to spend considerable time sifting through materials that are unsuitable or inappropriate for test-item development. To minimize the time wasted, this invention describes a system, apparatus, and method of retrieving media materials for generating test items. In one example, the system may query one or more data sources based on a search criteria for retrieving media materials, and receive candidate media materials based on the query, each of which including an audio portion. The system may obtain a transcription of the audio portion of each of the candidate media materials. The system may analyze the transcription for each candidate media material to identify characteristics of the associated candidate media material. The candidate media materials may be filtered based on the identified characteristics to derive a subset of the candidate media materials. A report may then be generated for the user identifying one or more of the candidate media materials in the subset. Exemplary systems comprising a processing system and a memory for carrying out the method are also described. Exemplary non-transitory computer readable media having instructions adapted to cause a processing system to execute the method are also described.

### BRIEF DESCRIPTION OF THE DRAWINGS

FIG. 1 is a block diagram depicting an embodiment of an audio/video retrieval system.

FIG. 2 is a flow diagram depicting an implementation of an audio/video retrieval system.

FIG. 3 is a flow diagram depicting an implementation of an audio-quality filter module for filtering retrieved audio/video materials.

FIG. 4 is a flow diagram depicting an implementation of a transcription-quality filter module for filtering retrieved audio/video materials.

FIG. 5 is a flow diagram depicting an implementation of a topic filter module for filtering retrieved audio/video materials.

FIG. 6 is a flow diagram depicting an implementation of a text-type filter module for filtering retrieved audio/video materials

FIG. 7 is a flow diagram depicting an implementation of a linguistic filter module for filtering retrieved audio/video materials

FIGS. 8A, 8B, and 8C depict example systems for use in implementing a system for retrieving materials for test-item development.

### DETAILED DESCRIPTION

The technology described herein relates to systems and methods for retrieving and selecting appropriate media materials (e.g., containing audio and/or video in addition to text) for developing test items, such as for language proficiency tests. In some implementations, the system may receive a keyword query from a user (e.g., a test developer) and use it to retrieve media materials that include speech audio. The retrieved materials may differ substantially in terms of audio quality (if they are audio or video files), vocabulary difficulty, syntactic complexity, distribution of technical terms and proper names, and/or other content and linguistic features that may influence the materials' usefulness to the user. Rather than returning all the retrieved materials to the user, the system may automatically filter out the materials with undesirable characteristics and only return a selected set that is more likely to be of use to the user. The information retrieval system described herein may therefore significantly reduce the amount of time spent by a test developer reviewing inadequate materials.

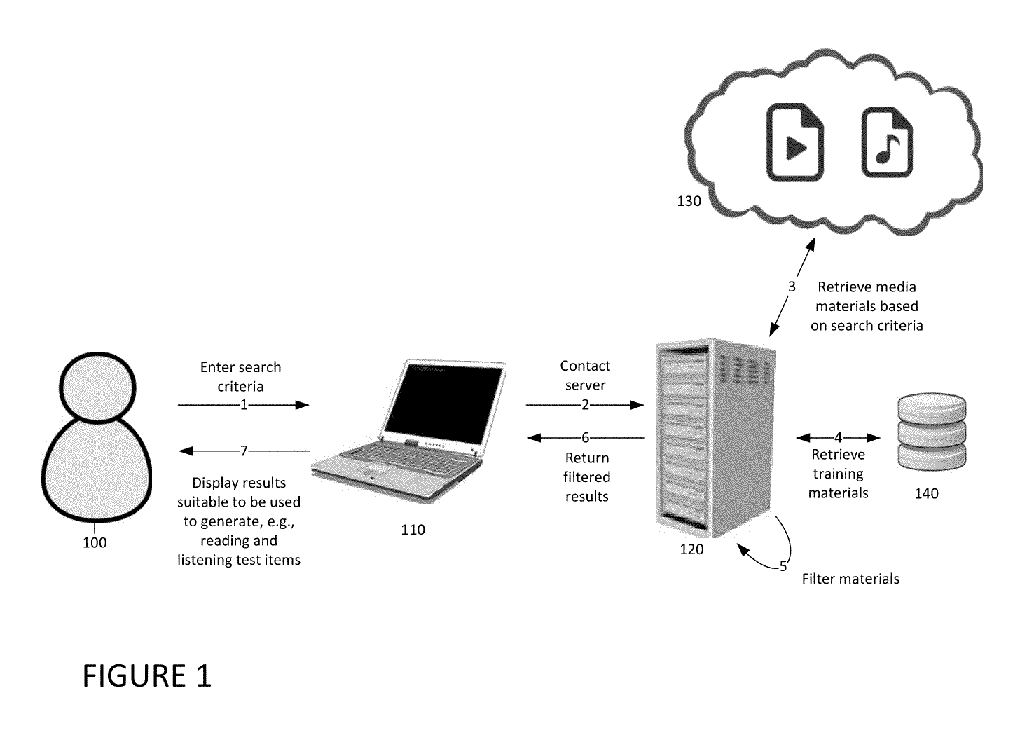

FIG. 1 shows a block diagram of an embodiment of the retrieval system. A user 100, such as a test developer, may enter a query into a computer 110 to specify the desired characteristics of materials in which he is interested. In some implementations, the entry may include any combination of keywords and selections from predetermined options (e.g., lists of predetermined topics, text types, etc.). In some implementations, the user 100 may also specify the threshold requirements for any retrieved materials' audio/video quality, the accuracy of their transcriptions, the level of similarity between their contents and the desired content (e.g., as indicated by the user's keywords), the linguistic features of interest, and/or the like. In some implementations, the computer 110 may query one or more databases, information repositories or any source on the World Wide Web generally based on the user's 100 input and transmit it to a server 120 through a network (e.g., Internet, LAN, etc.), and the server 120 may in turn carry out the user's 100 requests. In some other implementations, the operation may be performed by the computer 110 itself, or by a distributed system.

In an exemplary implementation where the server 120 carries out the operations, the server 120 may retrieve relevant media materials (e.g., containing audio, video, and/or text) based on the user's specification (e.g., keyword entry or selection). The materials may be retrieved from any source 130, such as the World Wide Web, a specific third-party source (e.g., YouTube.com), a repository of previously collected materials hosted remotely or locally, and/or the like. The server 120 may also retrieve training materials from a repository 140 (local or remote). The training materials may be existing test items similar to what that the test developer wishes to develop, or they may be samples selected by experts. As will be described in further detail below, the retrieved materials may undergo a variety of filtering and selection operations, some of which may utilize the training materials, to identify materials that are most likely to be useful to the user 100. The server 120 may then return the results to the user's computer 110, which may in turn display the results to the user 100. The user 100 may review and use the returned materials to develop new test items.

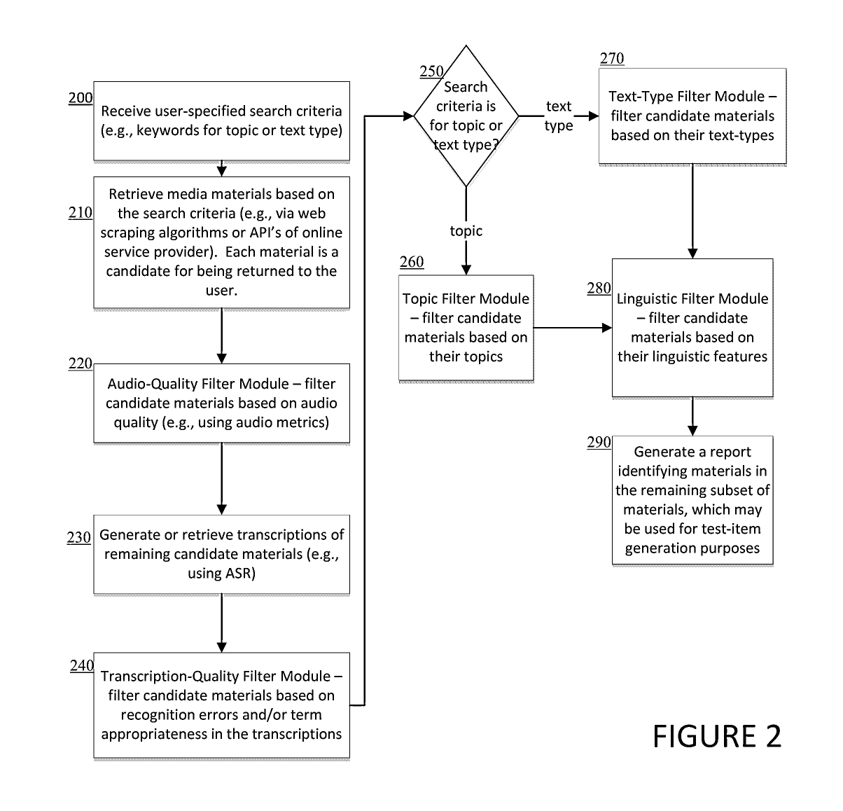

FIG. 2 depicts a flow diagram of an exemplary retrieval system for selecting appropriate materials based on a user's search criteria. The system may receive user inputs (e.g., keywords, selections, and/or the like) that specify one or more desired characteristics of a media material 200. For example, the user may specify topics (e.g., finance, health, sports, manufacturing, purchasing, etc.) and/or text types (e.g., presentation, advertising, local announcement, journal article, etc.) of interest.

The system may generate a query based on the user input 200 and use it to retrieve relevant media materials (e.g., audio, video, and/or text) 210. In addition to using the user input 200, the system in some implementations may also automatically add synonyms and closely related terms as search parameters (e.g., if the user entered the keyword “film,” the system may also search for “movies”). The system may query any combination of data sources, including the World Wide Web, private networks, specific databases, etc. The retrieval may be carried out by using Application Programming Interfaces (APIs) provided by online service providers, web scraping algorithms, audio/video search engines, and/or the like. For example, in some implementations the search may be based on a comparison of the user-entered keywords to a media's title, file name, metadata, hyperlink, contextual information (e.g., the content of the webpage where the media is found), user remarks, audiovisual indexes created by the hosting service, and other indicia of content. The retrieved materials may be considered as candidates for the final set of materials presented to the user.

The retrieved media materials are then filtered based on any number and combination of characteristics associated with the materials, such as, but not limited to, audio quality, transcription quality, content relevance to the user's search criteria, appropriateness of the linguistic features used, etc. The filtering modules described in detail below provide additional examples of how some characteristics are identified and analyzed for purposes of filtering out undesirable media materials.

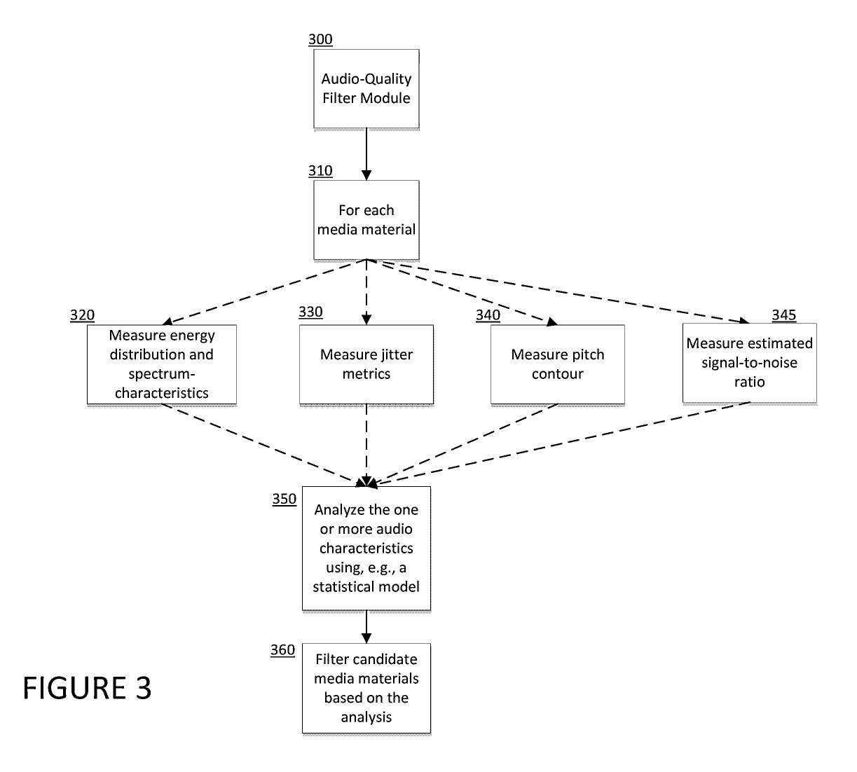

The audio quality of some of the retrieved candidate media materials may be unacceptably poor since the retrieval algorithm may not have taken into consideration audio quality. A material with poor audio quality may be unsuitable for use by the test developer or by the system (e.g., poor audio quality may hamper the system's ability to use speech recognition technology to transcribe the content). Therefore, in some embodiments the system may filter the retrieved materials based on audio quality 220. FIG. 3 shows an example of an audio quality filter module 300. The module may use any combination of audio metrics to extract features from each audio/video material 310 and determine whether to filter out the material based on those features. One exemplary audio metric is based on energy distributions and spectrum characteristics of audio/video materials 320. Since intelligible human speech is roughly between the frequency spectrum of 300 Hz and 3.4 kHz, the metric 320 may extract a material's acoustic spectral energy distribution to determine whether human speech (the sound within the speech spectrum) is sufficiently detectable. In some implementations, Mel-Frequency Cepstrum (MFC) may be used to represent the material's audio as a sequence of cepstral vectors. As will be described in more detail below (e.g., with respect to 350), in some implementations the cepstral vectors may be used as features in a statistical model for determining the sufficiency of audio quality.

Another audio feature that may be used for assessing audio quality is based on jitter measurements (i.e., irregularities/deviations in pitch periods), which is undesirable if excessive. Any conventional method for extracting jitter information from audio may be used. For example, the speech analysis software, PRAAT (developed by the University of Amsterdam), may be used to measure jitter information 330 from each of the audio/video materials 310. In some implementations, local frame-to-frame jitter may be measured, which in general is the average absolute difference between consecutive periods, divided by the average period. The jitter measurement may, in some implementations, be used as a feature in the statistical model for determining sufficiency of audio quality (e.g., at 350).

In addition to the above, any other conventionally known measures of audio or speech features may be employed. For example, the pitch contour 340 of each audio/video material 310 may be measured. In some implementations, the pitch contour may be compared to sample human pitch contours in the target language of the test items (e.g., English, Spanish, etc.). A similarity measure may be calculated based on, e.g., the root-mean-square deviations between the measured pitch contour and the sample pitch contours. The similarity measure of the pitch contours may also be used as a feature in the statistical model for assessing audio quality 350.

As another example, estimations of the signal-to-noise ratio 345 of each audio/video material 310 may be used. In situations where separate measurements of the “signal” and the “noise” for the audio/video materials are unavailable, the signal-to-noise ratio of the materials may be estimated based on assumptions about signal behavior and noise behavior. For example, the NIST STNR utility (National Institute of Standards and Technology Signal-to-Noise Ratio), developed by Columbia University, and the WADA method (Waveform Amplitude Distribution Analysis), developed by Carnegie Mellon University, may be used to estimate the signal-to-noise ratio of the audio/video materials. The estimated signal-to-noise ratio may again be used as a feature in the statistical model 350.

The audio feature measurements (e.g., 320, 330, 340, 345) for each audio/video material 310 may be input into a statistical model 350 to determine whether the material 310 should be filtered out or kept as a candidate for further analysis. In some implementations, the statistical model may be trained using training audio/video materials of known quality (e.g., as determined by human reviewers). For example, a model may be represented by a linear combination of weighted audio feature measurements (i.e., the independent variables) that predicts a value representing audio quality (i.e., the dependent variable). During training, the known quality of each training material, which may be represented numerically, would replace the dependent variable of the model, and the training material's audio feature measurements (e.g., obtained using the aforementioned audio metrics) would replace the independent variables. The goal of the training is to find weights for the independent variables that would optimize the predictability of the dependent variable. Regression analysis or any other model-training processes known to one of ordinary skill in the art may be used to determine the proper weights for the independent variables in the model. Once the model has been trained, the audio feature measurements of an audio/video material may be input into the model to obtain an audio quality score 350. Based on the score, the audio/video material may be retained as a candidate or filtered out 360. For example, if a audio quality score fails to meet a predetermined threshold, then the corresponding audio/video material may be filtered out of the group of candidate materials. The predetermined threshold may be based on empirical observations or be specified by the user.

Rather than training and using a model to analyze the audio measurements (e.g., at 350), an assessment of audio quality may be performed by directly comparing the audio measurements (e.g., 320, 330, 340, 345) to benchmark characteristics or values. Based on the comparison of the audio measurements to their respective benchmarks, the corresponding audio/video material may be retained or discarded. For example, in some implementations a material may be discarded for having any substandard audio measurement (e.g., a material may be filtered out if its estimated signal-to-noise ratio fail to meet a predetermined threshold).

Referring again to FIG. 2, the audio portions of the candidate materials may be transcribed 230 using automated speech recognition technology (ASR), well known in the art. Alternatively, the system may attempt to retrieve existing transcriptions of the materials. For example, the candidate materials may have been previously transcribed by the retrieval system (e.g., by using ASR or by human). In some cases, the data source from where the materials was retrieved may also provide transcriptions (e.g., using YouTube's API to automatically obtain transcriptions). The transcriptions enable text-based analysis tools to be used to assess the contents of the retrieved materials.

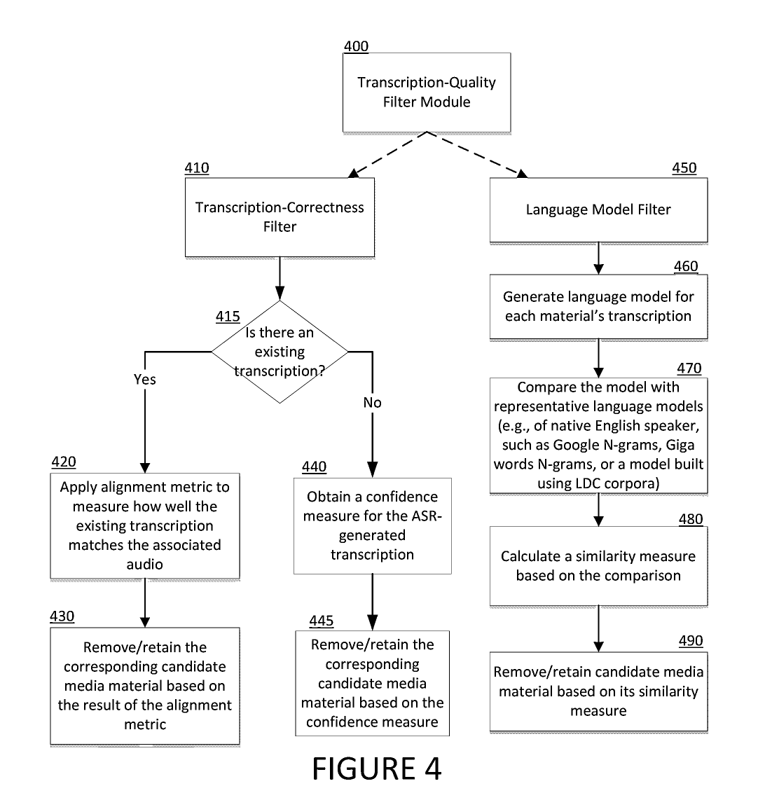

In some implementations, an initial screening of the transcriptions may be used to filter out unsuitable materials 240. FIG. 4 provides an example of a transcription-quality filter module 400 where filtering is based on a transcription's quality and/or inclusion of inappropriate terms. The Transcription-Correctness Filter 410 aims to filter out audio/video materials whose corresponding transcriptions contain excessive ASR-generated transcription errors. The approach taken by the Transcription-Correctness Filter 410 may depend on whether an audio/video material has an existing transcription (e.g., downloaded along with the material itself) or if a new transcription has to be generated using ASR technology 415. If a material has an existing transcription, a conventionally-known transcription quality metric may be used to assess how well the existing transcription matches the associated audio. For example, a speech-text alignment metric may be used to generate a score to represent the degree of alignment between the speech audio and transcription text. Based on the alignment score, the corresponding audio/video material may be removed or retained 430. For example, transcriptions with an alignment score below a predetermined threshold may warrant the removal of the corresponding audio/video material. The threshold may be empirically determined by human.

In cases where no existing transcription is available, the accuracy of an ASR-generated transcription may be scrutinized by using any confidence measure (CM) algorithm 440, such as the normalized acoustic score and N-best based confidence score, as described in L. Chase, “Word and Acoustic Confidence Annotation for Large Vocabulary Speech Recognition” (1997) and T. J. Hazen et. al, “Recognition Confidence Scoring and Its Use in Speech Understanding Systems” (2002), both of which are expressly incorporated by reference herein. Depending on the CM, the corresponding candidate material may be filtered out or retained 445. For example, if the CM of an ASR-generated transcription fails to meet a predetermined threshold (e.g., the CM is too low), then the corresponding material may be filtered out from the candidate group.

The candidate materials may also be scrutinized for including excessive undesirable/inappropriate terms. FIG. 4 depicts an exemplary Language Model Filter 450 that identifies transcriptions with unnatural word sequences (which may be caused by speech recognition errors), overly specialized terms/jargons targeted at specific audiences, expressions lacking elaboration. In some implementations, the system may generate a language model for each material's transcription 460. For example, the language model may be based on n-grams (e.g., of words, phonemes, syllables, etc.). The language model may then be compared to one or more representative language models of native speakers 470 (e.g., English, Spanish, etc., depending on the target language of interest) to estimate how natural the underlying language is. In some implementations, the representative language models may be pre-existing language models such as Google N-grams, Gigawords N-gram, and/or the like. Alternatively, the representative language model may also be built using pre-existing corpora such as the LDC corpora. The comparison of the language models may be performed by any conventional model-comparison algorithms, such by calculating the cross entropy between a generated language model for a material and the representative language model. In some implementations, the comparison may output a similarity measure 480. In implementations where the similarity measure is derived from cross entropy calculations, a small entropy may indicate that the generated language model is predictable (in light of the representative language model) and therefore more “natural” and desirable. Conversely, a large cross entropy may indicate, e.g., that the audio/video material includes unnatural or overly specialized language, and therefore may be unsuitable to be used for developing test-items. Based on a similarity measures, a corresponding audio/video material may be filtered out or retained 490. For example, if the similarity measure fails to meet a predetermined threshold, the corresponding audio/video material may be filtered out; conversely, if the similarity measure satisfies a predetermined threshold, the corresponding material may be retained for further consideration. The similarity threshold may be determined by, e.g., generating language models for training materials of known quality (e.g., obtained from pre-existing test items or selected by experts) and calculating the similarity measures between them and the representative language model. In some implementations, the similarity measures of the training material may be averaged, and that average measure may be used as the predetermined similarity threshold. In some other implementations, rather than using a predetermined threshold as the cut-off, the similarity scores of the candidate materials may be ranked, and the n materials with the best similarity scores may be retained and the rest filtered out.

In addition to filtering based on audio quality and transcription quality, the content of the materials may be compared against the user-entered search criteria to identify materials with the best match. In some implementations, the system may first parse the user's search criteria (e.g., from step 200) and determine whether the user has specified a desired topic or text type 250. For example, the words in the user's search criteria may be classified by comparing them to a collection of topic labels and a collection of text-type words. Alternatively, the system's user interface may allow the user to enter keywords or make selections in separate topic and text-type forms. Based on the classification of the user's search criteria, an appropriate filter module may be invoked. For example, if the search criteria specify a topic, a topic filter module 260 may be invoked to identify audio/video materials that are sufficiently similar to the user-specified topic.

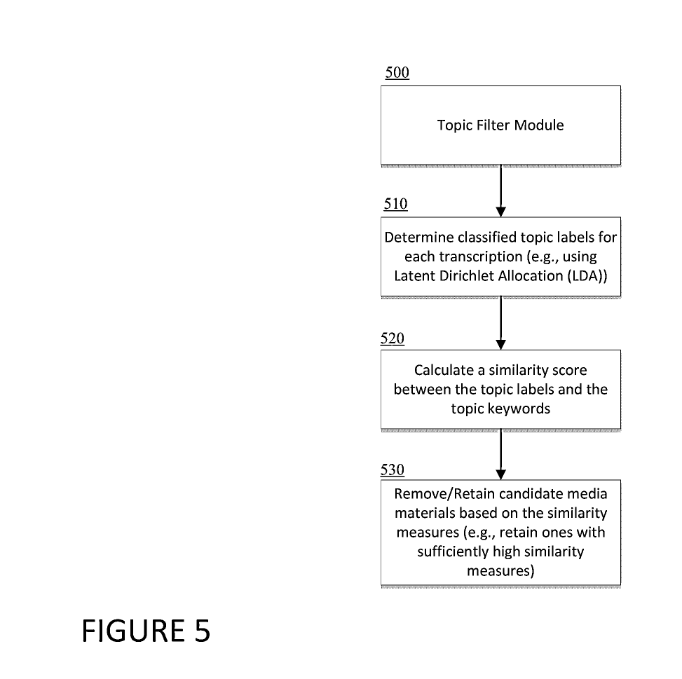

FIG. 5 depicts an exemplary flow diagram for a topic filter module 500. In some implementations, the system may analyze each audio/video material's transcription to determine a set of relevant topic labels 510. This may be performed by any topic modeling or topic classification algorithms known to one of ordinary skill in the art. For example, generative modeling, such as Latent Dirichlet Allocation (LDA), or topic modeling toolkits, such as Gensim, may be used to automatically and statistically identity potential topics for each transcription. As another example, a set of topics may be predetermined, and conventional clustering and/or classification algorithms may be used to determine in which of the set of predetermined topics a transcription belongs (e.g., based on a training set of transcriptions whose topic categorization is known). Then, the identified topic labels may be compared with the user-specified topic keyword(s) to calculate a similarity measure 520, which represents the topic similarity between the corresponding audio/video material and the topic(s) specified by the user. Any conventional semantic similarity measure may be used, such as latent semantic analysis (LSA), generalized latent semantic analysis (GLSA), pointwise mutual information (PMI), and/or the like. In another example, the similarity between topic labels may be determined based on their relationship within a lexical database, such as WordNet, developed by Princeton University. Any conventional similarity algorithms utilizing such lexical database may be used. For example, a similarity algorithm may locate the topic labels within WordNet's hierarchical word structure and count the number of edges (distance) between them and calculate a similarity score accordingly (e.g., shorter distances may indicate higher degrees of similarity, and longer distances may indicate higher degrees of dissimilarity). Based on the similarity measure 520, the corresponding audio/video material may be removed or retained accordingly 530. For example, if the similarity measure exceeds a predetermined threshold, which indicates that the topic labels derived from the transcription of the audio/video material are sufficiently similar to the user-specified topic(s), then the audio/video material may continue to be a candidate material. On the other hand, if the similarity measure does not meet a minimum threshold, then the corresponding audio/video material may be filtered out from the candidate materials. The appropriate threshold may be determined from empirical observations.

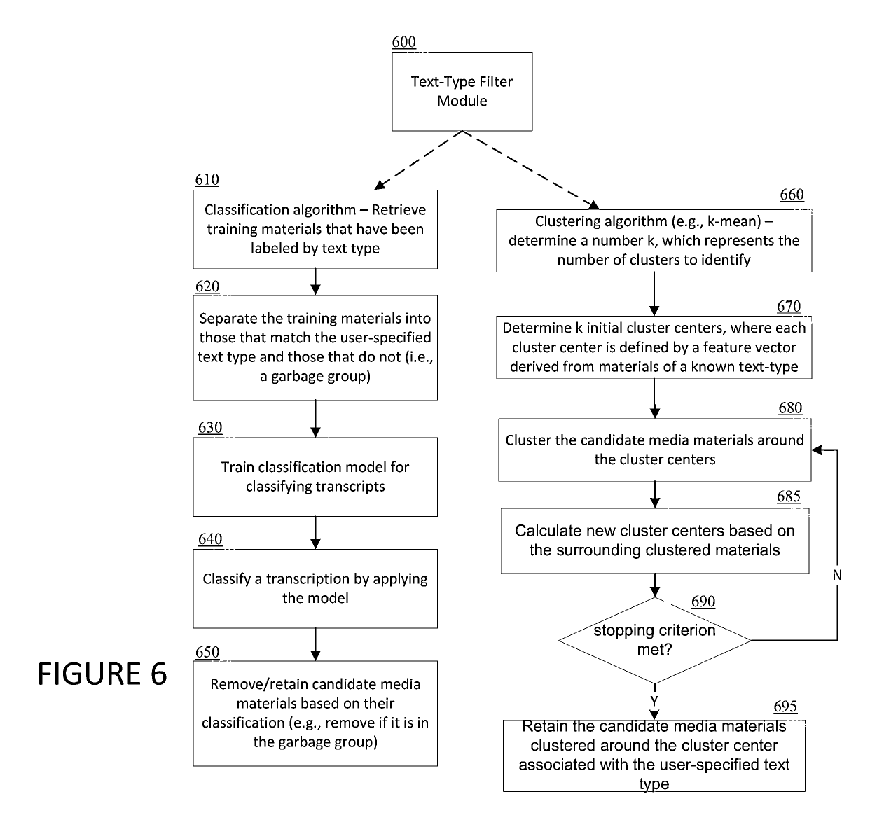

Referring again to FIG. 2, if the user-specified criteria indicates a desired text type, a text-type filter module 270 may be invoked. FIG. 6 illustrates an exemplary flow diagram for a text-type filter module 600 that utilizes one or both of a classification algorithm and a clustering algorithm. Supervised text classification algorithms may be used to identify materials that match the user-specified text type. In some implementations, the system may retrieve a collection of training materials that have been manually labeled/classified by text-type 610. The training materials may be separated into two categories: those having text types matching the user-specified text type (referred to as the target group) and those that do not (referred to as the garbage group) 620. In some implementations, the matching algorithm used for comparing the user-specified text type to the training materials' text types may be based on word distances within WordNet, as described above. In some other implementations where the scope of possible text types is limited by the user interface (e.g., the user can only select text types from a pre-determined list), each of the available text types may have an associated set of training materials, in which case there may be no need to use a matching algorithm.

The training materials in the target group and the garbage group may be used to train a classification model for classifying a given material's transcription into either of the groups 630. In some implementations, the classification model may use TF-IDF (Term Frequency-Inverse Document Frequency) values of words in a transcription as features for predicting whether the transcription belongs in the target or garbage group (TF-IDF is a numerical statistic that is intended to reflect how important a word is to the document). In other words, the classification model's independent variables may correspond to the TF-IDF values and the dependent variable may correspond to an indication of whether a transcription belongs in the target group or garbage group. Once the model has been trained, it can be applied to the collection of candidate materials to identify those that match the user-specified text type (i.e., those that fall into the target group) 640. The ones matching the user-specified text type may remain a candidate, and the ones that do not (i.e., those that fall into the garbage group) may be discarded 650.

In cases where the user's search criteria only includes a topic but not a text type, it may be desirable to return a collection of topic-relevant audio/video materials categorized by text type. For example, if the user is interested in materials relating to finance, he may be presented with categories of financial materials that are from lectures, presentations, news, etc. This may be implemented using a classification method similar to the one described above, but instead of training the classification model based on two categories (i.e., a target group and a garbage group), the training would be based on the training materials' text-type labels (e.g., lecture, conference article, journal, etc.). Thus, when the classification model is applied to a audio/video material, it would output a prediction of which text type the material would likely fall under.

The text-type filter module 600 may also use clustering algorithms to determine whether a material's text type matches the user-specified text type. For example, k-mean clustering (e.g., as implemented by Apache Mahout) and/or Expectation-Maximization algorithms may be used to automatically cluster the remaining candidate audio/video materials into groups. As known by persons of ordinary skill in the art, k-mean clustering algorithm iteratively cluster data around k closest cluster centers. In general, the algorithm is given a number k and a set of data (e.g., text documents) represented by numeric features in n dimensional space 660. Where the data is text, the numeric features may be TF-IDF vector values, as previously mentioned. Typically, the algorithm begins by randomly selecting k cluster centers in the n dimensional space and then clustering the given data around those k cluster centers (e.g., based on the calculated distances between the data points to the centers). However, since the goal of the text-type filter module 600 is to find materials of a specific user-specified text type, in some implementations the initial k cluster centers may be explicitly set, rather than randomly selected. For example, each of the initial k cluster centers may correspond to a known text type 670 (e.g., one cluster center may be derived from a collection of lectures, another cluster center may be derived from a collection of presentations, etc.). Having provided initial cluster centers that correspond to text types, the algorithm may then cluster the transcriptions of the audio/video materials around those cluster centers 680. The clustering algorithm may then recalculate each cluster's center based on the data clustered around it 685, and again cluster the data around the new centers 680. This process may iterate for a specified number of times or until the cluster centers stabilize 690. In some implementations, the audio/video materials represented by the final cluster associated with the user-specified text type would be retained 695.

In other implementations, the aforementioned k cluster centers may be randomly selected, and the transcriptions would be placed into k clusters according to the k-mean algorithm. After the k clusters of transcriptions have been determined, any cluster labeling algorithm may be used to pick descriptive labels for each of the clusters. In one example, cluster labeling may be based on external knowledge such as pre-categorized documents (e.g., human-assigned labels to existing test items or training documents). The process in some implementations may start by extracting linguistic features from the transcriptions in each cluster. The features may then be used to retrieve and rank n-nearest pre-categorized documents (e.g., pre-categorized documents with similar linguistic features). One of the n-nearest pre-categorized documents may be selected (e.g., the one with the best rank), and the pre-determined words (e.g., the category titles) used to describe that document may be used as the cluster label for the corresponding cluster of transcriptions. Each cluster of transcriptions may be labeled in this manner. Thereafter, the cluster labels may be compared to the user-specified text type, using any conventional semantics similarity algorithm, to identify the best-matching cluster. The final materials presented to the user may be selected from the best-matching cluster.

Referring again to FIG. 2, the candidate materials may be further filtered based on the complexity of the language used 280. In some implementations, complexity may be assessed based on linguistic features extracted from the transcriptions of the audio/video materials. For example, the Text Evaluator, developed by Education Testing Service, may be used to assess the linguistic complexity of the transcriptions (the associated U.S. Pat. No. 8,517,738 is hereby incorporated by reference). The scores output by the Text Evaluator may be compared to a predetermined threshold, which may be specified by the user. The audio/video materials with corresponding complexity scores failing to meet the threshold may be filtered out.

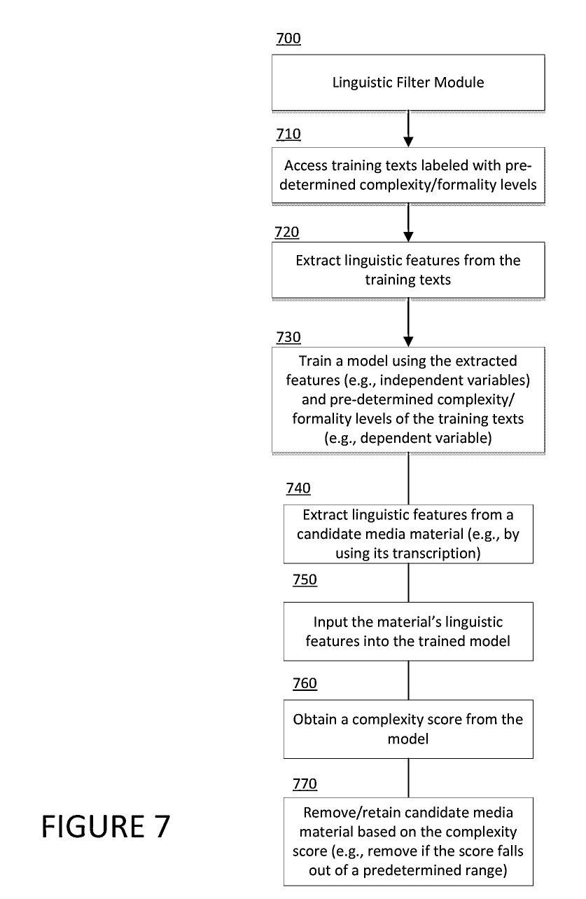

FIG. 7 illustrates an embodiment of a linguistic filter module 700 for filtering materials based on text complexity or other text characteristics. A statistical model, represented by, e.g., a linear combination of linguistic features, may be used to predict a complexity score for each transcription. To build the model, a collection of training texts with predetermined complexity levels (e.g., as determined by human reviewers) may be obtained 710. Various linguistic features of the training texts may then be extracted from each of the training texts 720. The linguistic features may include, but not limited to: (1) difficulty of vocabulary (e.g., based on the number of abstract nouns, ratio of academic words to content words, average frequency of words appearing in familiar word lists, and/or the like); (2) syntactic characteristics (e.g., based on the depth of parsed trees, the average sentence length, the number of long sentences, the number of dependent clauses per sentence, the number of relative clauses and/or concatenated clauses, and/or the like); (3) distribution of proper nouns, technical terms, and abbreviations; (4) level of concreteness; (5) cohesion; and/or the like. The model may then be trained using the extracted linguistic features as values for the model's independent variables and the predetermined complexity levels of the training texts as values for the dependent variable 730. In some implementations, linear regression may be used to determine the optimal weights/coefficients for the independent variables. The set of optimal weights/coefficients may then be incorporated into the model for predicting text complexity. To use the model to assess a candidate audio/video material's transcription, the first step in some implementations may be to extract the aforementioned linguistic features from the transcription 740, and then input the feature values into the model as the values for the independent variables 750. The output of the model may be a numerical complexity score that represents the text complexity of the transcription 760. If the complexity score fails to reach a predetermined threshold (e.g., which may be specified by the user), then the corresponding audio/video material may be filtered out; otherwise, the material may remain a candidate 770.

In another implementation, candidate audio/video materials may be filtered based on the formality level of the speech therein. For example, some materials may use speech that is overly formal (e.g., in news reporting or business presentations) or overly informal (e.g., conversations at a playground or bar) for purposes of test item generation. In one implementation, a model for predicting formality level may be trained, similar to the process described above with respect to complexity levels. For example, a collection of training materials with predetermined formality levels (e.g., as labeled by human) may be retrieved, and various linguistic features of the training materials may be extracted. A model (e.g., represented by a linear combination of variables) may then be trained using the extracted linguistic features as values for the independent variables and the predetermined formality levels as values for the dependent variable. In some implementations, linear regression may be used to determine the optimal weights/coefficients for the independent variables. The set of optimal weights/coefficients may then be incorporated into the model for predicting formality levels. The model may be applied to the transcriptions (specifically, the linguistic features of the transcriptions) of the candidate audio/video materials to predict the formality level of the speech contained therein. The candidate audio/video materials may then be filtered based on the formality levels and a predetermined selection criteria (e.g., formality levels above and/or below a certain threshold may be filtered out).

In some instances it may also be desirable to filter out audio/video materials based on the level of inclusion of inappropriate words, such as offensive words or words indicating that the topic relates to religion or politics. In some implementations, a list of predetermined inappropriate words may be retrieved. Each transcript may then be analyzed to calculate the frequency in which the inappropriate words appear. Based on the frequency of inappropriate-word occurrences (e.g., as compared to a predetermined threshold), the corresponding candidate audio/video material may be filtered out.

Referring again to FIG. 2, once filtering is complete, a report (e.g., an web page, a document, a graphical user interface, etc.) may be generated based on the remaining subset of candidate materials 290. In some cases, the subset could be the entire set of media materials retrieved (e.g., if nothing was filtered out). In some implementations, a ranking score may be calculated for each candidate material in the subset based on, e.g., the scores it obtained from any combination of the filter modules. For example, the ranking score may be a weighted sum of the output from the audio-quality filter module (FIG. 3), the transcription-quality filter module (FIG. 4) the topic filter module (FIG. 5), the text-type filter module (FIG. 6), and/or the linguistic filter module (e.g., FIG. 7). The report of materials presented to the user may be generated based on the ranking scores. For example, the materials may be sorted based on their ranking scores, or only the materials with the n highest ranking scores would be presented.

As one of ordinary skill in the art would recognize, the filters described herein may be applied in any sequence and are not limited to any of the exemplary embodiments. For example, the linguistic filter module may be applied first, followed by the transcription-quality filter, followed by the audio-quality filter, and followed by the text-type filter and topic filter. In addition, one or more of the filters may be processed concurrently using parallel processing. For example, each of the filters may be processed on a separate computer/server and the end results (e.g., similarity scores, model outputs, filter recommendations, etc.) may collectively be analyzed (e.g., using a model) to determine whether a media material ought to be filtered out. Furthermore, the retrieval system may utilize a subset or all of the filters described herein.

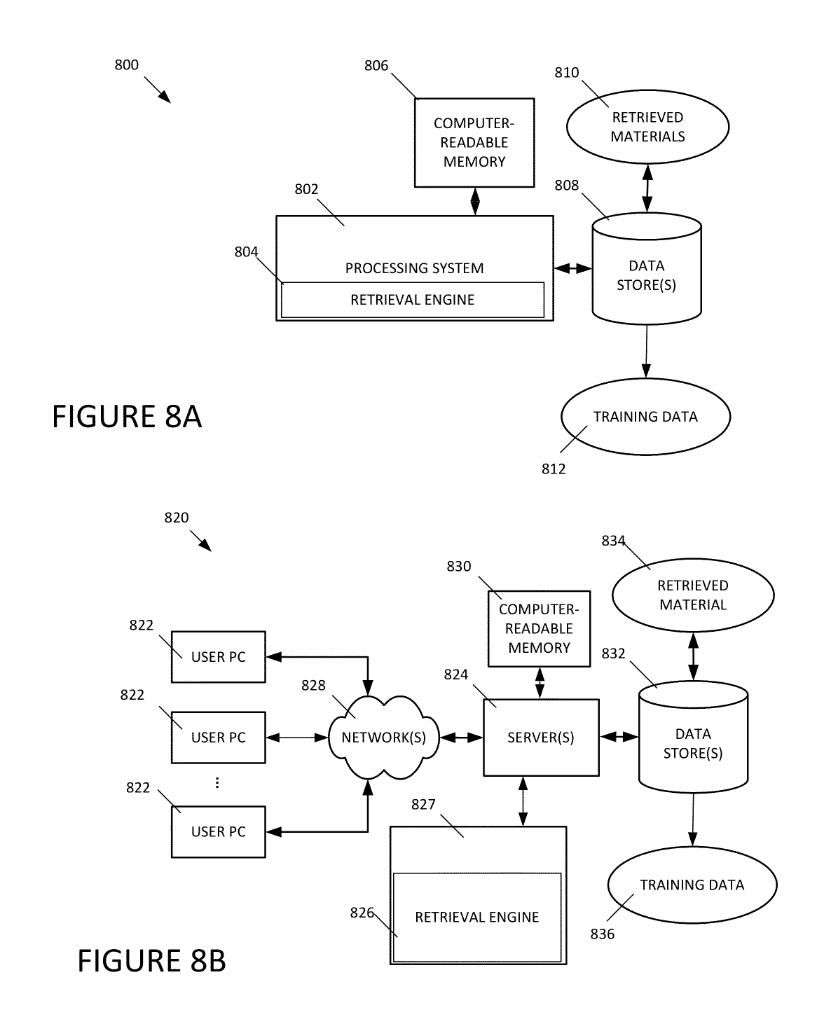

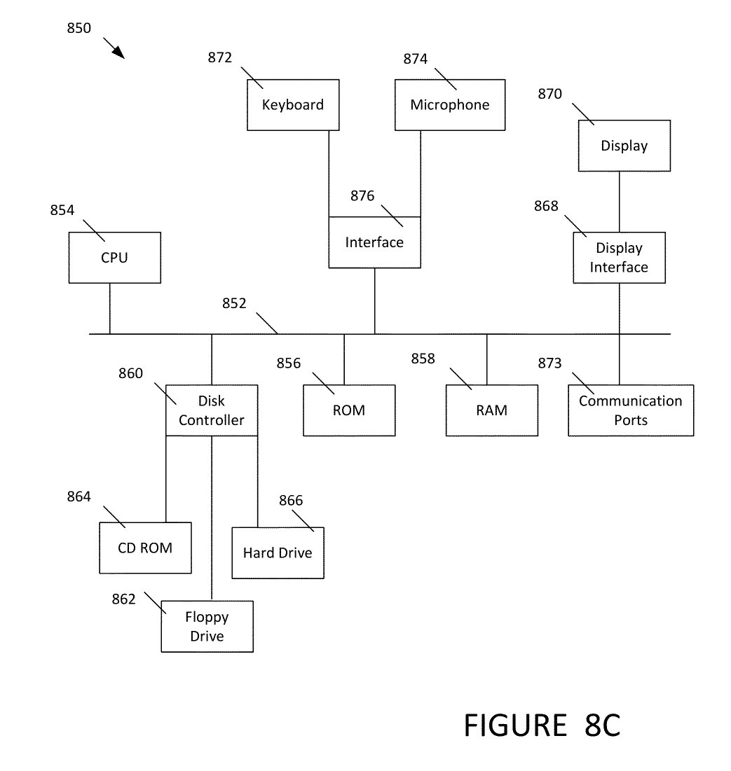

Additional examples will now be described with regard to additional exemplary aspects of implementation of the approaches described herein. FIGS. 8A, 8B, and 8C depict example systems for use in implementing a retrieval system described herein. For example, FIG. 8A depicts an exemplary system 800 that includes a standalone computer architecture where a processing system 802 (e.g., one or more computer processors located in a given computer or in multiple computers that may be separate and distinct from one another) includes a retrieval engine 804 being executed on it. The processing system 802 has access to a computer-readable memory 806 in addition to one or more data stores 808. The one or more data stores 808 may include the retrieved materials (e.g., audio, video) 810 as well as pre-annotated/labeled training data 812.

FIG. 8B depicts a system 820 that includes a client server architecture. One or more user PCs 822 access one or more servers 824 running a retrieval engine 826 on a processing system 827 via one or more networks 828. The one or more servers 824 may access a computer readable memory 830 as well as one or more data stores 832. The one or more data stores 832 may contain retrieved materials 834 as well as training data 836.

FIG. 8C shows a block diagram of exemplary hardware for a standalone computer architecture 850, such as the architecture depicted in FIG. 8A that may be used to contain and/or implement the program instructions of system embodiments of the present invention. A bus 852 may serve as the information highway interconnecting the other illustrated components of the hardware. A processing system 854 labeled CPU (central processing unit) (e.g., one or more computer processors at a given computer or at multiple computers), may perform calculations and logic operations required to execute a program. A non-transitory processor-readable storage medium, such as read only memory (ROM) 856 and random access memory (RAM) 858, may be in communication with the processing system 854 and may contain one or more programming instructions for performing the method of implementing a scoring model generator. Optionally, program instructions may be stored on a non-transitory computer readable storage medium such as a magnetic disk, optical disk, recordable memory device, flash memory, or other physical storage medium.

A disk controller 860 interfaces one or more optional disk drives to the system bus 852. These disk drives may be external or internal floppy disk drives such as 862, external or internal CD-ROM, CD-R, CD-RW or DVD drives such as 864, or external or internal hard drives 866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 860, the ROM 856 and/or the RAM 858. Preferably, the processor 854 may access each component as required.

A display interface 868 may permit information from the bus 852 to be displayed on a display 870 in audio, graphic, or alphanumeric format. Communication with external devices may optionally occur using various communication ports 873.

In addition to the standard computer-type components, the hardware may also include data input devices, such as a keyboard 872, or other input device 874, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. A computer-implemented method of retrieving media materials for generating test items, comprising:
querying with a processing system one or more data sources based on a search criteria for retrieving media materials;
receiving candidate media materials based on the query, each candidate media material having an audio portion;
obtaining a transcription of the audio portion of each of the candidate media materials;
analyzing the transcription with the processing system for each candidate media material to identify characteristics of the associated candidate media material;
filtering, using the processing system, the candidate media materials based on the identified characteristics to derive a subset of the candidate media materials;
generating a report for the user identifying one or more of the candidate media materials in the subset.

2. The method of claim 1, comprising:
measuring one or more audio characteristics of each candidate media material;
analyzing the one or more audio characteristics of each candidate media material; and
filtering out some of the candidate media materials based on the analysis of the associated one or more audio characteristics.

3. The method of claim 2, wherein at least one of the audio characteristics is based on audio energy distribution and spectrum characteristics, audio jitter, audio pitch contour, or estimated signal-to-noise ratio.

4. The method of claim 2, wherein the step of analyzing the one or more audio characteristics includes inputting the one or more audio characteristics into a statistical model for predicting audio quality, wherein the statistical model is trained using training media materials with predetermined indicia of audio quality.

5. The method of claim 1, comprising:
determining a transcription quality for each of the transcriptions;
filtering out some of the candidate media materials based on the determined transcription quality of the associated transcriptions.

6. The method of claim 5, wherein the transcription quality may be based on at least one of text-speech alignment metric and transcription confidence measure.

7. The method of claim 1, comprising:
generating a language model for each of the candidate media materials based on its associated transcription;
calculating a similarity score between a representative language model and each of the generated language models;
filtering out some of the candidate media materials based on the associated similarity scores.

8. The method of claim 1, comprising:
determining at least one topic label for each of the candidate media materials based on its associated transcription;
calculating a similarity score between at least a portion of the search criteria and each transcription's associated topic label;
filtering out some of the candidate media materials based on the associated similarity scores.

9. The method of claim 8, wherein the step of determining the at least one topic label includes using a classification or clustering algorithm to determine which of a set of predetermined topic labels each of the candidate media materials belong to.

10. The method of claim 1, comprising:
retrieving training materials whose predetermined text types satisfy the search criteria;
extracting linguistic features from each of the training materials;
training a model using at least the training materials and the associated linguistic features;
applying the model to each transcription to predict whether it is of a text type that satisfies the search criteria;
filtering out some of the candidate media materials based on the associated model predictions.

11. The method of claim 1, comprising:
using a clustering algorithm to cluster the transcripts into a predetermined number of clusters;
identifying text types associated with each cluster;
filtering out some of the candidate media materials based on the search criteria and the text types of the clusters.

12. The method of claim 1, comprising:
retrieving training materials with predetermined complexity scores;
extracting linguistic features from the training materials;
training a model for predicting complexity score using the extracted linguistic features and the predetermined complexity scores of the training materials;
applying the model to the transcriptions of the candidate media materials to determine their complexity scores;
filtering out some of the candidate media materials based on the associated determined complexity scores.

13. The method of claim 1, comprising:
retrieving training materials with predetermined formality levels;
extracting linguistic features from the training materials;
training a model for predicting formality level using the extracted linguistic features and the predetermined formality levels of the training materials;
applying the model to the transcriptions of the candidate media materials to determine their formality levels;
filtering out some of the candidate media materials based on the associated determined formality levels.

14. The method of claim 1, comprising:
retrieving a list of inappropriate words;
calculating, for each of the transcriptions, a frequency of the inappropriate words appearing in the transcription;
filtering out some of the candidate media materials based on the associated calculated frequencies.

15. A system for retrieving media materials for generating test items, comprising:
a processing system; and
a memory, wherein the processing system is configured to execute steps comprising:
querying one or more data sources based on a search criteria for retrieving media materials;
receiving candidate media materials based on the query, each candidate media material having an audio portion;
obtaining a transcription of the audio portion of each of the candidate media materials;
analyzing the transcription for each candidate media material to identify characteristics of the associated candidate media material;
filtering the candidate media materials based on the identified characteristics to derive a subset of the candidate media materials;
generating a report for the user identifying one or more of the candidate media materials in the subset.

16. The system of claim 15, wherein the processing system is configured to execute steps comprising:
measuring one or more audio characteristics of each candidate media material;
analyzing the one or more audio characteristics of each candidate media material; and
filtering out some of the candidate media materials based on the analysis of the associated one or more audio characteristics.

17. The system of claim 15, wherein the processing system is configured to execute steps comprising:
determining a transcription quality for each of the transcriptions;
filtering out some of the candidate media materials based on the determined transcription quality of the associated transcriptions.

18. The system of claim 15, wherein the processing system is configured to execute steps comprising:
generating a language model for each of the candidate media materials based on its associated transcription;
calculating a similarity score between a representative language model and each of the generated language models;
filtering out some of the candidate media materials based on the associated similarity scores.

19. The system of claim 15, wherein the processing system is configured to execute steps comprising:
determining at least one topic label for each of the candidate media materials based on its associated transcription;
calculating a similarity score between at least a portion of the search criteria and each transcription's associated topic label;
filtering out some of the candidate media materials based on the associated similarity scores.

20. The system of claim 15, wherein the processing system is configured to execute steps comprising:
retrieving training materials whose predetermined text types satisfy the search criteria;
extracting linguistic features from each of the training materials;
training a model using at least the training materials and the associated linguistic features;
applying the model to each transcription to predict whether it is of a text type that satisfies the search criteria;
filtering out some of the candidate media materials based on the associated model predictions.

21. The system of claim 15, wherein the processing system is configured to execute steps comprising:
retrieving training materials with predetermined complexity scores;
extracting linguistic features from the training materials;
training a model for predicting complexity score using the extracted linguistic features and the predetermined complexity scores of the training materials;
applying the model to the transcriptions of the candidate media materials to determine their complexity scores;
filtering out some of the candidate media materials based on the associated determined complexity scores.

22. A non-transitory computer-readable medium for retrieving media materials for generating test items, comprising instructions which when executed cause a processing system to carry out steps comprising:
querying one or more data sources based on a search criteria for retrieving media materials;
receiving candidate media materials based on the query, each candidate media material having an audio portion;
obtaining a transcription of the audio portion of each of the candidate media materials;
analyzing the transcription for each candidate media material to identify characteristics of the associated candidate media material;
filtering the candidate media materials based on the identified characteristics to derive a subset of the candidate media materials;
generating a report for the user identifying one or more of the candidate media materials in the subset.

23. The non-transitory computer-readable medium of claim 22, comprising instructions which when executed cause the processing system to carry out steps comprising:
measuring one or more audio characteristics of each candidate media material;
analyzing the one or more audio characteristics of each candidate media material; and
filtering out some of the candidate media materials based on the analysis of the associated one or more audio characteristics.

24. The non-transitory computer-readable medium of claim 22, comprising instructions which when executed cause the processing system to carry out steps comprising:
determining a transcription quality for each of the transcriptions;
filtering out some of the candidate media materials based on the determined transcription quality of the associated transcriptions.

25. The non-transitory computer-readable medium of claim 22, comprising instructions which when executed cause the processing system to carry out steps comprising:
generating a language model for each of the candidate media materials based on its associated transcription;
calculating a similarity score between a representative language model and each of the generated language models;
filtering out some of the candidate media materials based on the associated similarity scores.

26. The non-transitory computer-readable medium of claim 22, comprising instructions which when executed cause the processing system to carry out steps comprising:
determining at least one topic label for each of the candidate media materials based on its associated transcription;
calculating a similarity score between at least a portion of the search criteria and each transcription's associated topic label;
filtering out some of the candidate media materials based on the associated similarity scores.

27. The non-transitory computer-readable medium of claim 22, comprising instructions which when executed cause the processing system to carry out steps comprising:
retrieving training materials whose predetermined text types satisfy the search criteria;
extracting linguistic features from each of the training materials;
training a model using at least the training materials and the associated linguistic features;
applying the model to each transcription to predict whether it is of a text type that satisfies the search criteria;
filtering out some of the candidate media materials based on the associated model predictions.

28. The non-transitory computer-readable medium of claim 22, comprising instructions which when executed cause the processing system to carry out steps comprising:
retrieving training materials with predetermined complexity scores;
extracting linguistic features from the training materials;
training a model for predicting complexity score using the extracted linguistic features and the predetermined complexity scores of the training materials;
applying the model to the transcriptions of the candidate media materials to determine their complexity scores;
filtering out some of the candidate media materials based on the associated determined complexity scores.
